(19) United States
(12) Patent Application Publication
(10) Pub. No.: US 2026/0107162 A1
(43) Pub. Date: Apr. 16, 2026

(54) Methods and Apparatus for Supporting WiFi and Cellular Communications in An Integrated Device

(71) Applicant: Charter Communications Operating, LLC, St. Louis, MO (US)

(72) Inventors: Aaron Nead, Highlands Ranch, CO (US); Daniela Capoj, Englewood, CO (US); Ryan Loaiza, Brighton, CO (US); Taren G. McCullough, Plymouth, MN (US)

(21) Appl. No.: 18/912,563

(22) Filed: Oct. 10, 2024

(51) Int. Cl. H04W 24/04; H04W 48/18; H04W 84/12

(52) U.S. Cl. CPC H04W 24/04; H04W 48/18; H04W 84/12

(57) ABSTRACT

Methods and apparatus for providing a communications device a wireless backhaul, e.g., cellular backhaul, in the event or of a cable, e.g., wired cable or optical cable, backhaul without the need for a dedicated cellular modem for this purpose are described. When a cellular backhaul is required, e.g., due to a failure of a cable based backhaul, the cellular module is operated as a cellular modem to thereby provide a cellular backhaul. By default, the integrated cellular module will operate as a femtocell, providing cellular connectivity to user equipments (UEs), e.g., smartphones, e.g., when the wired or optical backhaul normally used is operating properly. In the event of an ISP network outage, the integrated cellular module will reconfigure from operating as a femtocell to operating as a cellular modem, thereby providing cellular WAN connectivity which can serve as a cellular backhaul to devices connected to the communications device via WiFi.

### FIELD

The present application relates to methods and apparatus for supporting wireless communications, and more particularity to methods and apparatus for supporting reliable wireless communications, e.g., WiFi and/cellular wireless communications.

### BACKGROUND

Femtocells are small, low-powered cellular base stations, designed to provide cellular connectivity as a mini cell tower in homes or small business sites. Femtocells use Internet Service Providers (ISPs) broadband connection to backhaul cellular traffic to the mobile network operator's core network, e.g., a 5G core mobile network. Femtocells can be either deployed as a separate device to a wireless router, e.g., a wireless local area network router, e.g., WLAN router, or can be integrated into the router, e.g., a WiFi router for example. Thus, both WiFi and cellular connectivity can be provided to an ecosystem by deploying a femtocell at a location including a WiFi router. Femtocells require connectivity to the IP network as a backhaul, through a router/modem.

Drawing 100 of FIG. 1 includes an exemplary home or small business site 102, which includes a cellphone 110 supporting 5G cellular wireless communications, a computer 102 supporting WiFi communications, a femtocell base station 104, a router 106 supporting WiFi communications, and a cable modem 108. The femtocell 104 is coupled to router 106 via communications link 118. The router 106 is coupled to cable modem 108 via communications link 120. The cellphone 110 may, and sometimes does, have a wireless cellular connection with femetocell 104 over which cellular signals are communicated. The computer 112 may, and sometimes does, have a WiFi connection with router 106, via which WiFi signals are communicated.

Drawing 100 further illustrates Internet 114 and 5G core mobile network. The cable modem 108 is coupled to Internet 114 via communications link 122, and Internet 114 is coupled to 5G core mobile network 116 via communications link 124.

Cellular modems are devices that add cellular connectivity to laptops, routers, etc. When cellular modems are integrated with WiFi routers, it allows for dual wider area network (WAN) connectivity: 1) wired WAN through ISP network, e.g., via a cable modem (CM) or Optical Network Unit (ONU); and 2) cellular WAN through a Radio Access Network (RAN), e.g., a MNO (e.g., Verizon, AT&T, etc.) RAN.

Dual WAN connectivity could be utilized in multiple ways. In one example, in the event of a network outage, the ecosystem can maintain connectivity through the event. In another example, traffic can be load balanced between wired and cellular WAN.

FIG. 2 includes a drawing 200 which illustrates a router with cellular back during a no outage mode of operation, as indicated by information box 201, and a drawing 250 which illustrates the router with cellular back up during an outage mode of operation. Drawing 200 includes a home or small business site 202 including a computer 212 with WiFi connectivity, a WiFi router 206 with cellular back up and a cable modem 208. The computer 212 may, and sometimes does, has a WiFi connection with router 206. Router 206 is coupled to cable modem 208 via communications link 208. Cable modem 208 is coupled to cable modem termination system 209 via communications link 222, and CMTS is coupled to Internet 214 via communications link 214.

Drawing 250 includes the home or small business site 202 including the computer 212 with WiFi connectivity, the WiFi router 206 with cellular back up, but does not show cable modem 208, e.g. since there is an outage. The computer 212 may, and sometimes does, have a WiFi connection with router 206. Router 206 is coupled to macro cell base station 211 via its cellular modem back-up module, which is active, and wireless cellular communications link 226. Macro cellular base station 211 is coupled to Internet 214 via communications link 228.

A femtocell requires an ISP broadband connection to provide cellular service. In the event of a network outage, the service becomes unusable. Cellular modems, incorporated into WiFi routers, provide dual connectivity but do not offer any fronthaul benefits. For example, if a client is not associated to the WiFi network, it will be unable to offload its traffic. Based on current approaches, a system that provides the benefits of both femtocell and cellular modems would require a minimum of two independent devices, creating additional complexity, increasing power draw, being aesthetically displeasing, and/or undesirable from a hardware perspective.

Based on the above discussion there is a need for new efficient methods and apparatus to support wireless communications. It would be desirable if these new methods and apparatus supported cellular communications, WiFi communications, and alternative backhaul path capability. It would be advantages if at least some of these new methods and apparatus limited the amount of cellular hardware deployed, limited the amount of power expended, and/or made efficient use of an available cellular module.

### SUMMARY

Methods and apparatus for providing a communications device a wireless backhaul, e.g., cellular backhaul, in the event or of a cable, e.g., wired cable or optical cable, backhaul failure are described. Significantly, the wireless backhaul for redundancy is supported without requiring a cellular transceiver dedicated exclusively to serving as a backhaul device with a cellular transceiver normally used to support cellular base station, e.g., femtocell operation. being switched to operating as a cellular modem to provide cellular backhaul connectivity in the event of a cable backhaul failure. In some cases, the cable backhaul is implemented using a cable modem but in other embodiments an optical fiber backhaul is used.

In at least some embodiments, a communications device, which includes a Wireless Wide Area Network access point (e.g., a WiFi access point) and a single cellular module, supports multiple modes of operation, e.g., a normal mode of operation (sometimes referred to as a no outage mode of operation) and a cellular backhaul mode of operation (sometimes referred to as an outage mode of operation). The modes of operation are implemented at different times with the cellular backhaul mode of operation being implemented when a wired or optical backhaul connection to a network is detected.

The single cellular module is utilized to act as either a femtocell or a cellular modem dynamically, depending upon what is required in the ecosystem.

When a cellular backhaul is required, e.g., due to a failure of a wire cable based or optical cable based backhaul, the cellular module is operated as a cellular modem to thereby provide a cellular backhaul. The cellular module is designed to include appropriate components to operate in both modes. By default, the integrated cellular module will operate as a femtocell, providing cellular connectivity to user equipments (UEs), e.g., smartphones, e.g., when the wired or optical backhaul normally used is operating properly. In the event of an ISP network outage, the integrated cellular module will reconfigure from operating as a femtocell to operating as a cellular modem, thereby providing cellular WAN connectivity which can serve as a cellular backhaul to devices connected to the communications device via the non-cellular WLAN, e.g., via WiFi. Once the ISP network outage has been resolved, the integrated cellular module will reconfigure as a femtocell. Since the same cellular module is utilized to perform different functions at different times, the cost and number of devices needed in one installment is minimalized. In some embodiments, the communications device includes a single cellular communications module and no other cellular communications modules. Thus, such embodiments are hardware efficient in that they include a single cellular transmitter and cellular receiver (cellular transceiver) which can be used in different ways depending on the availability/functionality of a wired backhaul where the wired backhaul could be a cable backhaul or optical fiber cable backhaul.

In various embodiments the WLAN access point is a WiFi access point that uses one or more of the IEEE 802.11 standards to communication with stations sometimes referred to a STAs. Thus in various embodiments the WLAN access point is a WiFi access point and the STAs are WiFi capable devices but the embodiment need not be limited to a particular WiFi standard and various WLAN wireless protocols can be used to support communication between WLAN access points and stations. To the extent that WiFi access points and WiFi stations are discussed and used to explain various exemplary embodiments they are to be understood as exemplary.

An exemplary method of operating a communications device including a WLAN, e.g., WiFi, access point and cellular communications module, in accordance with some embodiments, comprises: operating the communications device in a normal mode of operation, said step of operating the communications device in a normal mode of operation including: i) operating the cellular communications module as a femtocell at a customer premises where the communications device is located, ii) operating the WLAN access point to provide WLAN service, e.g., WiFi service, at the customer premises, and iii) communicating data over a first backhaul communications connection, said first backhaul communications connection being a cable or optical backhaul connection; monitoring, during the normal mode of operation, the first backhaul communications connection; switching the communications device from the normal mode of operation to a cellular backhaul mode of operation in response to detecting a first backhaul communications connection outage; and operating in the cellular backhaul mode of operation during at least a portion of the first backhaul communications connection outage, wherein operating in the cellular backhaul mode of operation includes using the cellular communications module to operate as a cellular modem instead of as a femtocell while continuing to operate the WLAN access point to provide WLAN service.

Numerous additional features, benefits and embodiments are discussed in the detailed description which follows. While various features discussed in the summary are used in some embodiments it should be appreciated that not all features are required or necessary for all embodiments and the mention of features in the summary should in no way be interpreted as implying that the feature is necessary or critical for all embodiments. Numerous additional features and embodiments are discussed in the detailed description which follows. Numerous additional benefits will be discussed in the detailed description which follows.

### BRIEF DESCRIPTION OF THE FIGURES

FIG. 1 is a drawing illustrating a femtocell deployed at a site including a router.

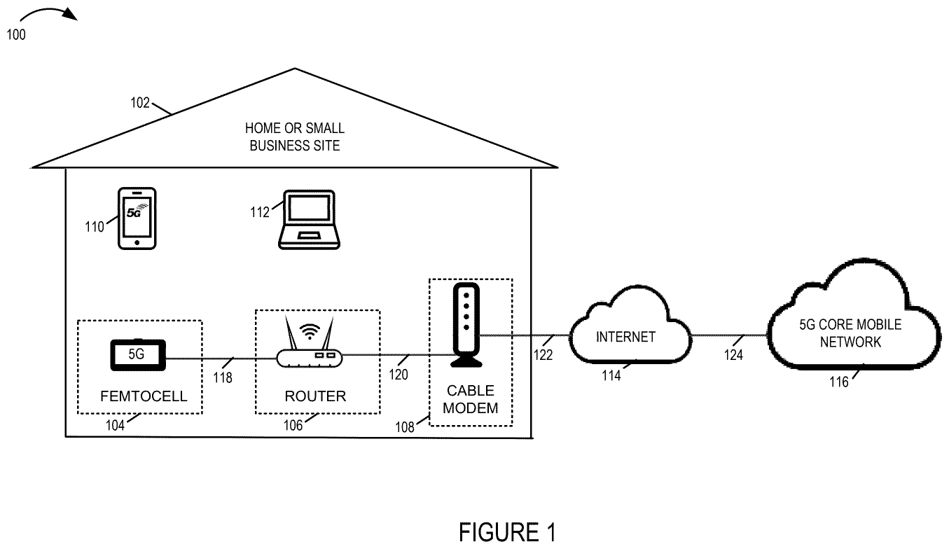

FIG. 2 is a drawing illustrating a deployed router with cellular backup during a no outage mode and during an outage mode.

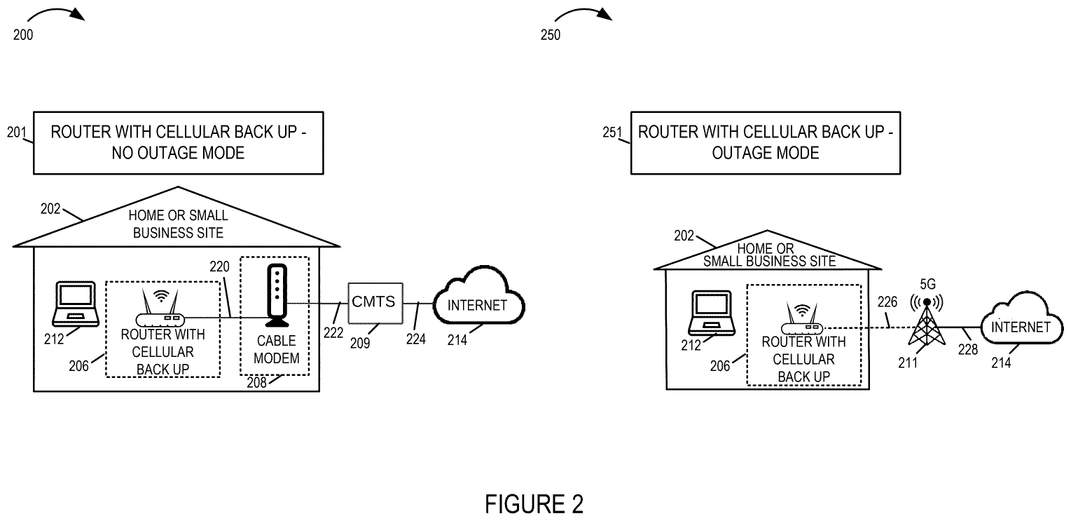

FIG. 3 includes a drawing illustrating an integrated communications device, in accordance with an exemplary embodiment, during a normal mode (no outage mode) in which the single cellular module functions as a femtocell, and a drawing illustrating the integrated communications device during an outage mode, in which the single cellular module functions as a cellular modem.

FIG. 4 is a drawing of an exemplary communications system in accordance with an exemplary embodiment, said exemplary communications system including a plurality of integrated communications devices, e.g., integrated communications device including a cellular module which can be used as either a femtocell or a cellular modem.

FIG. 5 is a drawing of an exemplary integrated communications device, in accordance with an exemplary embodiment, said exemplary integrated communications device including a cellular module which can be used as either a femtocell or a cellular modem.

FIG. 6A is a drawing of a first part of a flowchart of an exemplary method of operating an integrated communications device in accordance with an exemplary embodiment.

FIG. 6B is a drawing of a second part of a flowchart of an exemplary method of operating an integrated communications device in accordance with an exemplary embodiment.

FIG. 6 comprises the combination of FIG. 6A and FIG. 6B.

FIG. 7 is a drawing illustrating the system of FIG. 4 for a scenario in which both first and second integrated communications devices are operating in a normal mode of operation.

FIG. 8 is a drawing illustrating the system of FIG. 4 for a scenario in which a first integrated communications device is operating in a outage mode of operation and a second integrated communications device is operating in a normal mode of operation.

FIG. 9 is a flowchart of an exemplary method of operating a communications device including a WiFi access point and a cellular communications module, in accordance with an exemplary embodiment.

### DETAILED DESCRIPTION

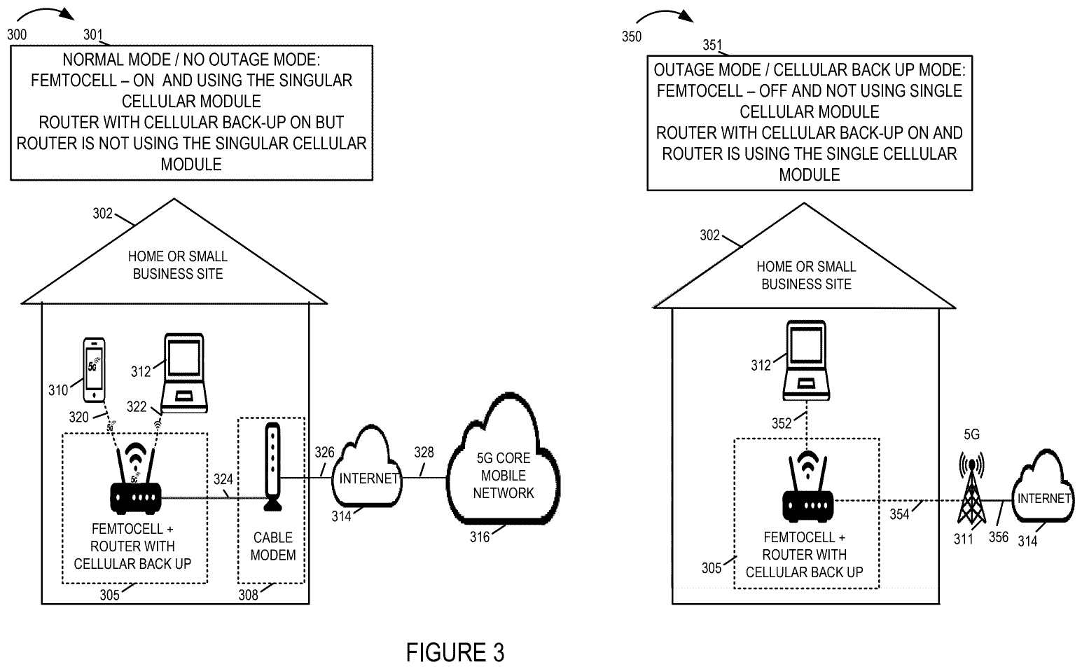

FIG. 3 includes a drawing 300 illustrating an exemplary integrated communications device 305, in accordance with an exemplary embodiment, during a normal mode (no outage mode) in which the single cellular module functions as a femtocell, as indicated by information block 301, and a drawing 350 illustrating the exemplary integrated communications device 350 during an outage mode (cellular back up mode) in which the single cellular module functions as a cellular modem and the femtocell is off, as indicated by information block 351. Exemplary integrated communications device 305 is referred to as a femtocell+router, e.g., WLAN router, with cellular back up. The exemplary integrated communications device 305 includes a single cellular module, which is controlled to operate as either a femtocell or as a cellular modem, depending upon the mode of operation. In normal mode, sometimes referred to as no outage mode, which is also the default mode, the single cellular module functions as a femtocell, providing cellular connectivity to one or more wireless cellular user equipments (UEs), and the router uses its cable interface for backhaul connectivity for both the communication of data/information corresponding the cellular end user devices, e.g., 5G UEs and WLAN, e.g., WiFi, end user devices, e.g., WiFi STAs. In outage mode, indicating an outage or other problem, e.g., unacceptable degraded level of performance, with the cable connection backhaul path, the single cellular module in the integrated communications device 305 functions as a cellular modem for the router, providing a cellular back up and facilitating continued communications for the WLAN, e.g., WiFi, STAs; however, the femtocell is off during this mode of operation, and communications for the cellular UEs is not supported.

For purposes of explaining the invention, various embodiments will be discussed in terms of examples where the WLAN router supports WiFi and is capable of acting as a WiFi access point. In such an exemplary embodiment WLAN stations are implemented as WiFi stations.

FIG. 300 illustrates an exemplary home or small business site 302 which includes a user equipment (UE) 310, e.g., a cellphone supporting 5G cellular communications, a computer 312 including a WLAN, e.g., WiFi, station (STA), the integrated communications device 305, and a cable modem 308 coupled together as shown. The single cellular module in the integrated communications device 305 is being used, in the example of drawing 300, as a femtocell base station. There is a 5G cellular wireless link 320 between UE 310 and the femtocell base station included in integrated communications device 305. There is a WLAN, e.g., WiFi, wireless communications link 322 between the WiFi STA in computer 312 and the WiFi access point (AP) included in the WiFi router of integrated communications device 305. Integrated communications device 305 is coupled, via its cable interface and cable communications link 324 to cable modem 308. Cable modem 308 is coupled to Internet 314 via communications link 326. The Internet 314 is coupled, via communications link 328, to a 5G core mobile network 316, which is the core mobile network for the femtocell. In the example of drawing 300, the router, included as part of the integrated communications device 305, is using its landline, e.g., cable, interface, for backhaul, and cellular back up is not being used and is not available, single the single cellular module is being used as a femtocell.

FIG. 350 illustrates the exemplary home or small business site 302 which includes the computer 312 including a WiFi station (STA), the integrated communications device 305. The single cellular module in the integrated communications device 305 is being used, in the example of drawing 350 as a cellular modem for the router. In the example of drawing 350 the UE 310 is not shown, since the femtocell is not active, and the cable modem 308 is not shown since backhaul signaling is not being communicated via cable modem 308. There is a WiFi wireless communications link 352 between the WiFi STA in computer 312 and the WiFi access point (AP) included in the WiFi router of integrated communications device 305. Integrated communications device 305 is coupled, via the cellular module, which is included in the integrated communications device and which is functioning as cellular modem, to a macro cell base station 311, via cellular wireless communications link 354. In this example, the router in integrated communications device 305 is using its cellular back up, for backhaul communications. Macro cell base station 311 is coupled to the Internet 314 via communications link 356.

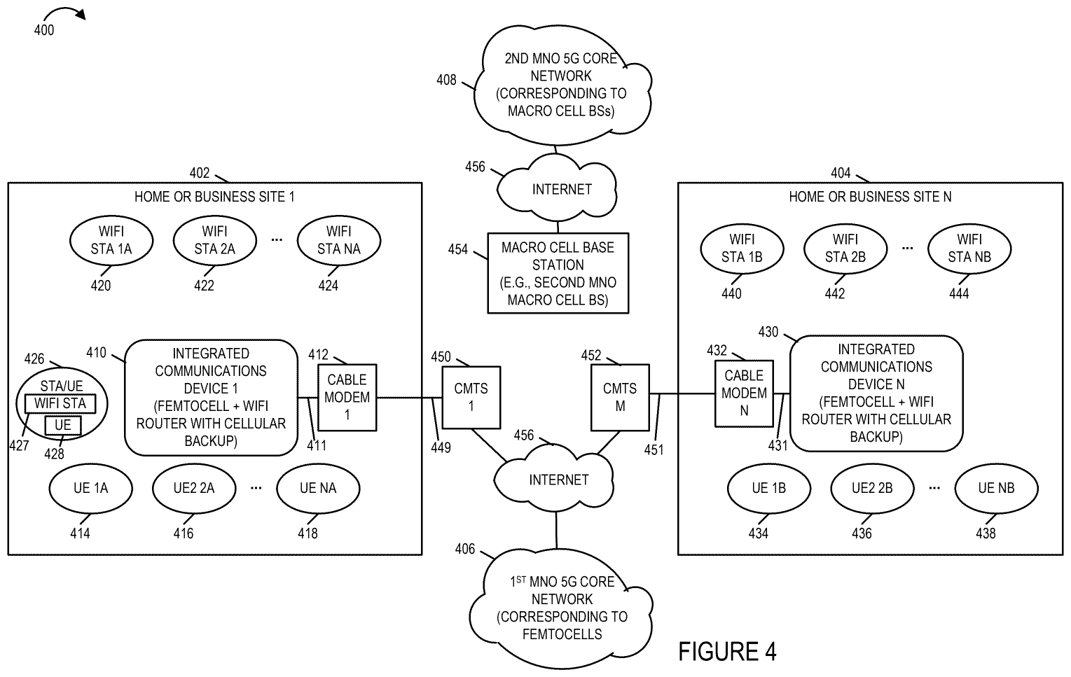

FIG. 4 is a drawing of an exemplary communications system 400 in accordance with an exemplary embodiment. Exemplary communications system 400 includes a plurality of home or business sites (home or business site 1 402, . . . , home or business site N 404), a plurality of cable modem termination systems (CMTS) (CMTS 1 450, . . . , CMTS M 452), Internet 456, a 1st mobile network operator (MNO) 5G core network 406, which corresponds to the femtocell base stations, and a 2nd MNO 5G core network 408, which corresponds to macro cell base stations, coupled together as shown.

Home or business site 1 402 includes integrated communications device 1 410 (femtocell+WiFi router with cellular backup) and cable modem 1 412, which are coupled together via communications link 411, e.g., a wired or optical connection. The femtocell base station supports cellular communications with UEs, and the WiFi router includes a WiFi AP which supports WiFi communications with WiFi stations. The router includes backhaul connectivity via a cable modem or a cellular backup. Home or business site 1 402 further includes one or more user equipments (UEs) supporting cellular communications (UE 1A 414, UE 2A 416, . . . , UE NA 418), e.g., cellphones supporting 5G wireless cellular communications with a femtocell base station. Home or business site 1 402 further includes one or more WiFi stations (STAs) (WiFi STA 1A 420, . . . , WiFi STA 2 422, . . . , WiFi STA NA 424) supporting WiFi communications with a WiFi access point. Home or business site 1 402 further includes one or more end user communications device, which support both WiFi and cellular communications, e.g., STA/UE device 426, which includes a WiFi STA module 427, e.g., supporting WiFi communications, and a UE module supporting cellular communications, e.g. 5G cellular communications.

Home or business site N 404 includes integrated communications device N 430 (femtocell +WiFi router with cellular backup) and cable modem N 432, which are coupled together via communications link 431, e.g., a wired or optical connection. The femtocell base station supports cellular communications with UEs, and the WiFi router includes a WiFi AP which supports WiFi communications with WiFi stations. The router includes backhaul connectivity via a cable modem or a cellular backup. Home or business site N 404 further includes one or more user equipments (UEs) supporting cellular communications (UE 1B 434, UE 2B 436, . . . , UE NB 438), e.g., cellphones supporting 5G wireless cellular communications with a femtocell base station. Home or business site N 404 further includes one or more WiFi stations (STAs) (WiFi STA 1B 440, . . . , WiFi STA 2B 442, . . . , WiFi STA NB 444) supporting WiFi communications with a WiFi access point.

Cable modem 1 412 is coupled to CMTS 1 450 via communications link 449. Cable mode N 432 is coupled to CMTS M 452 via communications link 451. CMTS 1 452 and CMTS M 452 are coupled to 1st MNO 5G core network 406 via Internet 456. Macro cell base station 454 is coupled to 2nd MNO 5G core network 408 via Internet 456.

WiFi STAs (420, 422, . . . , 424) may be, and sometimes are, coupled to a WiFi AP, which is part of integrated communications device 1 410, via wireless WiFi communications links. WiFi communications are supported during both the normal (no outage) and outage modes of operation. UEs (414, 416, . . . , 418) may be, and sometimes are, coupled to a femtocell base station which is part of integrated communications device 1 410 during the normal (no outage) mode of operation.

WiFi STAs (440, 442, . . . , 444) may be, and sometimes are, coupled to a WiFi AP, which is part of integrated communications device N 430, via wireless WiFi communications links. WiFi communications are supported during both the normal (no outage) and outage modes of operation. UEs (434, 436, . . . , 438) may be, and sometimes are, coupled to a femtocell base station which is part of integrated communications device N 410 during the normal (no outage) mode of operation.

If integrated communications device 1 410 is operating in the normal (no outage) mode of operation, the backhaul for cellular and WiFi communications is via communications link 411, cable mode 1 412, CMTS 1 450, Internet 456 and 1st MNO core network 406. If integrated communications device 1 410 is operating in the outage mode of operation, its cellular module functions as a cellular modem, and the backhaul for WiFi communications is via a communications path including a cellular wireless communications link between the cellular modem of the integrated communications device 1 410 and macro cell base station 454, and Internet 456.

If integrated communications device N 430 is operating in the normal (no outage) mode of operation, the backhaul for cellular and WiFi communications is via communications link 431, cable mode N 432, CMTS M 452, Internet 456 and 1st MNO core network 406. If integrated communications device N 430 is operating in the outage mode of operation, its cellular module functions as a cellular modem, and the backhaul for WiFi communications is via a communications path including a cellular wireless communications link between the cellular modem of the integrated communications device N 430 and macro cell base station 454, and Internet 456.

In some embodiments, one of more of the cable modems are included in an integrated communications device, e.g., cable modem 1 412 is included in integrated communications device 1 410. In some embodiments one or more of the cable modems (412, . . . , 432) are replaced by an optical network unit (ONU).

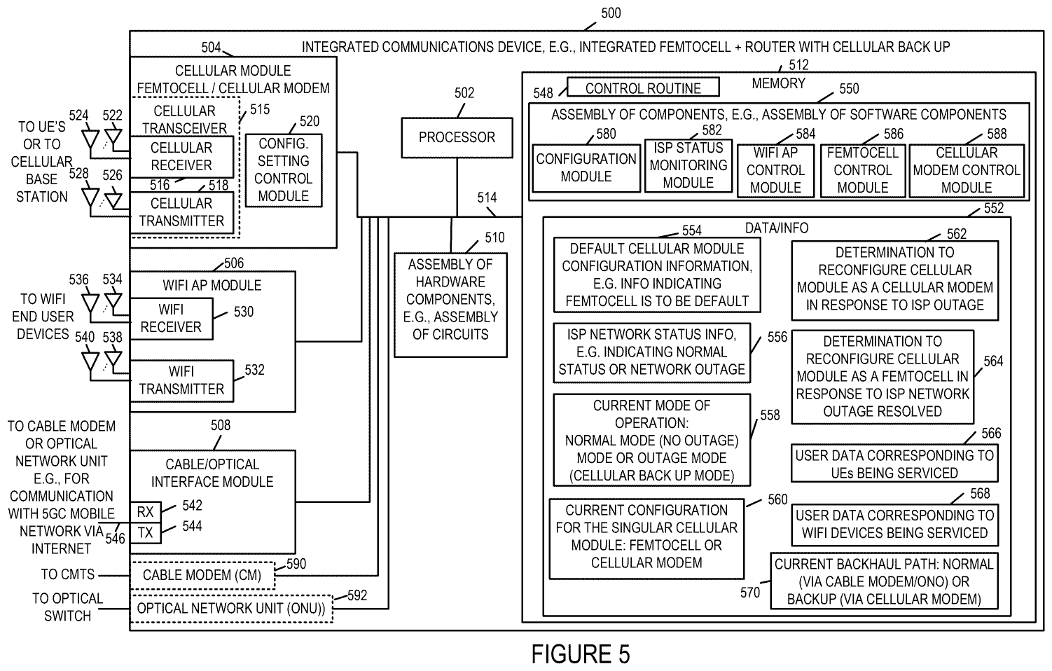

FIG. 5 is a drawing of an exemplary integrated communications device 500, in accordance with an exemplary embodiment, said exemplary integrated communications device including a cellular module which can be used as either a femtocell or a cellular modem. Integrated communications device 500 is, e.g., any of integrated communications device 305 of FIG. 3, integrated communications device 1 410 of FIG. 4 or integrated communications device N 430 of FIG. 4. Integrated communications device 500 includes a processor 502, e.g., a CPU, a single cellular module 504, which can be configured to function as a femtocell base station or as a cellular modem, a WiFi access point (AP) module 506, a cable/optical interface module 508, an assembly of hardware components 510, e.g., an assembly of circuits, and memory 512 coupled together via bus 514 over which the various elements may interchange data and information. In some embodiments, integrated communications device includes an embedded cable modem (CM) 590 and/or an embedded optical network unit (ONU) 592.

Cellular module 504 includes a cellular receiver 516, a cellular transmitter 518 and configuration setting control module 520. In some embodiments, the cellular receiver 516 and cellular transmitter 518 are part of a single cellular transceiver 515 included in the integrated communications device 500. Cellular receiver 516 is coupled to one or more receive antennas or antenna elements (522, . . . , 524) via which the integrated communications device 500 receives cellular wireless signals, e.g. 5G uplink cellular wireless signals from UEs, when cellular module 504 is operating as femtocell base station, or 5G cellular wireless signals from a macro cellular base station, when cellular module 504 is operating as a cellular modem, as part of a router cellular backup. Cellular transmitter 518 is coupled to one or more transmit antennas or antenna elements (526, . . . , 528) via which the integrated communications device 500 transmits cellular wireless signals, e.g. 5G downlink cellular wireless signals to UEs, when cellular module 504 is operating as femtocell base station, or to 5G cellular wireless signals to a macro cellular base station, when cellular module 504 is operating as a cellular modem, as part of a router cellular backup. Configuration setting control module 520 is used to configure and re-configure cellular module 504, between operating as a femtocell or operating as cellular modem, e.g. in response to ISP network outage status determinations.

WiFi AP module 506, which is part of the WiFi router functionality of integrated communications device 500, includes a WiFi receiver 530 and WiFi transmitter 532. WiFi receiver 530 is coupled to one or more WiFi receive antennas or antenna elements (534, . . . , 536) via which the integrated communications device 500 receives WiFi signals from WiFi end user devices, e.g., WiFi STAs. WiFi transmitter 532 is coupled to one or more WiFi transmit antennas or antenna elements (538, . . . , 540) via which the integrated communications device 500 transmits WiFi signals to WiFi end user devices, e.g., WiFi STAs.

Cable/optical interface module 508 includes receiver 542, transmitter 544 and connector 546. Cable/optical interface module couples the integrated communications device 500 to a cable modem or an optical network unit (ONU) for supporting communications with a 5GC core network via the Internet, when the router of integrated communications device 500 is operating in a normal mode of operation, e.g., due to no outage detected of ISP. The cable/optical interface module 508 provides a primary path connection for a backhaul connection to integrated communications device 500.

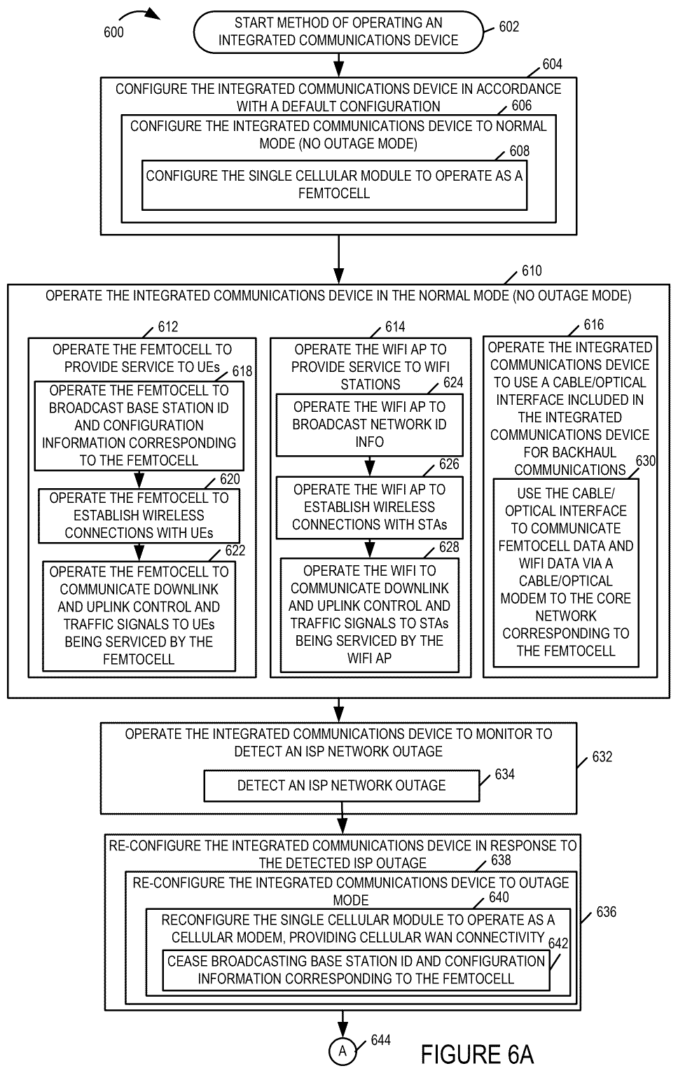

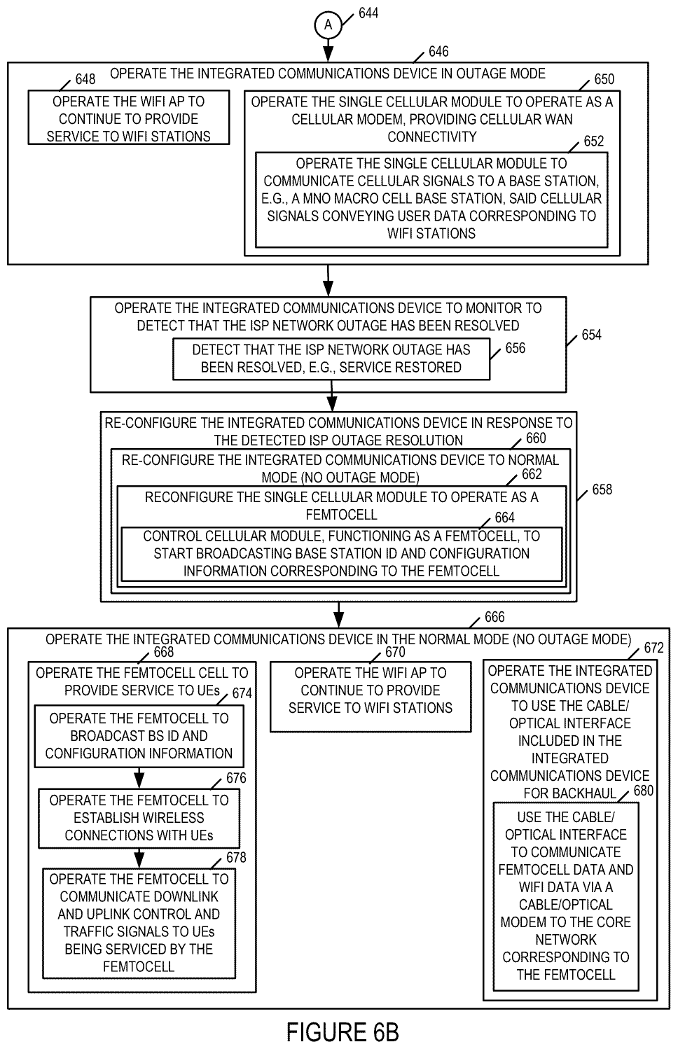

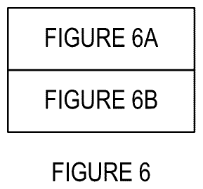

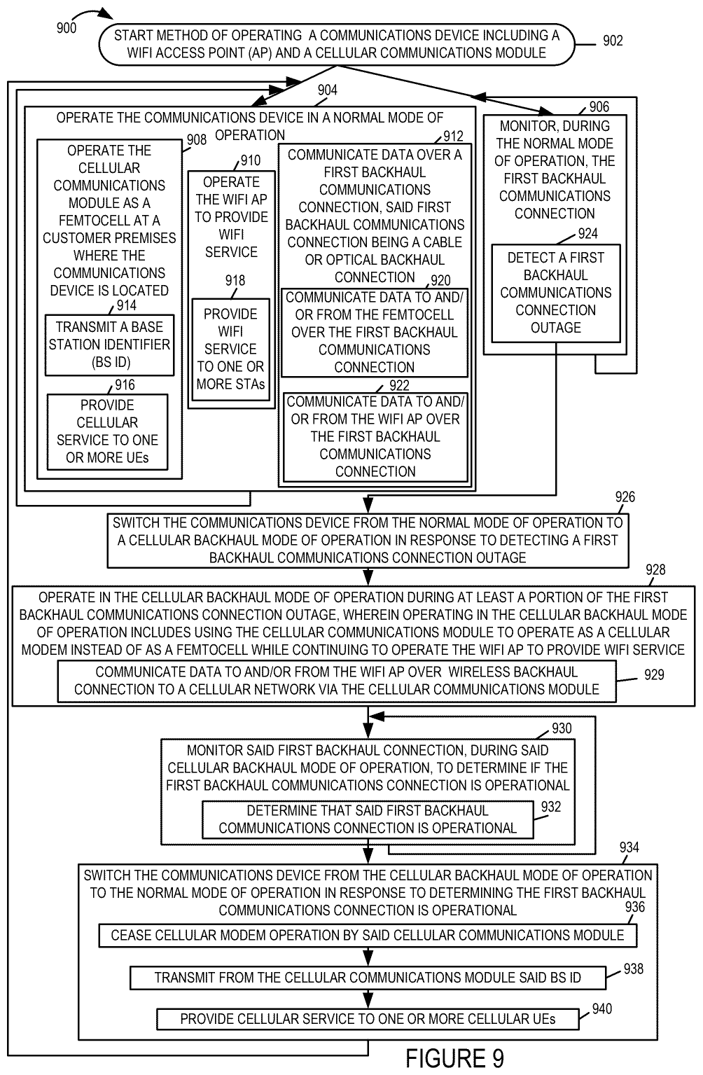

Memory 512 includes a control routine 548, and assembly of components 550, e.g., an assembly of software components, and data/information 552. Assembly of components 550 includes a configuration module 580, and ISP status monitoring module 582, a WiFi AP control module 584, a femtocell control module 586, and a cellular modem control module 588. Control routine 548 includes instructions which when executed by processor 502 controls the integrated communications device to implement basic operational functions, e.g., read memory, write to memory, control an interface, load a program, subroutine, or app, etc. Assembly of components 550, e.g., an assembly of software components, e.g., routines, subroutines, applications, etc., includes, e.g., code, e.g., machine executable instructions, which when executed by processor 502, controls the integrated communications device 500 to implement steps of a method, e.g., steps of the method of flowchart 600 of FIG. 6 and/or steps of the method of flowchart 900 of FIG. 9. Configuration module 580 control the integrated communications device to implement steps and operation related to configuration initialization and configuration changes, e.g., configurating the integrated device in normal mode (no outage mode) or outage mode (cellular back up mode), and configuring the cellular communications module to function as a femtocell or to function as a cellular modem. ISP status monitoring module 582 control the integrated communications device to monitor a first backhaul communications connection (a non-wireless cable or optical backhaul connection) to detect for an outage condition while in normal mode of operation and to detect for an operational status condition (restoration of the first backhaul connection), when in the outage mode of operation (cellular back-up mode). WiFi AP control module 584 control operation of the WiFI AP module 506. Femtocell control module 586 controls operation of the cellular communications module 504, when it is configured as a femtocell. Cellular modem control module 508 controls operation of the cellular communications module 504, when it is configured to operate a cellular modem, during a cellular backhaul mode of operation, and functions, to communicate, e.g., relay, WiFi data via cellular signals, e.g., with the cellular communications module of integrated communications device 500 communicating wirelessly with a wireless device of a cellular network, e.g., a macro base station, and providing an alternative backhaul path for the integrated communications device 500 to send/receive WiFi traffic data.

Data/information 552 includes default cellular module configuration information 554, e.g., information indicating femtocell is to be default, ISP network status information 556, e.g., information indicating normal status or network outage, current mode of operation 558 indicating normal (no outage) mode or outage mode (cellular back up mode), current configuration for the single cellular module 560, e.g., information indicating femtocell or cellular modem, determination to reconfigure the cellular module as cellular modem in response to a detected ISP outage 562, determination to reconfigured the cellular module as a femtocell in response to an ISP network outage resolved condition 564, user data 566 corresponding to UEs being serviced by the femtocell, user data 568 corresponding to WiFi devices, e.g. WiFi STAs, being service by the WiFi AP, and information 570 indicating current backhaul path: i) normal (via cable modem or ONU) or backup (via cellular modem).

FIG. 6, comprising the combination of FIG. 6A and FIG. 6B, is a flowchart 600 of an exemplary method of operating an integrated communications device, e.g., any of integrated communications device 305 of FIG. 3, integrated communications device 1 410 of FIG. 4, integrated communications device N 430 of FIG. 4, or integrated communications device 500 of FIG. 5, in accordance with an exemplary embodiment. Operation of the exemplary method starts in step 602 in which the integrated communications device is powered on and initialized. Operation proceeds from start step 602 to step 604.

In step 604 the integrated communications device is operated to configure in accordance a stored default configuration. Step 606 includes step 606 in which the integrated communications device is operated to configured to normal mode (no outage mode). Step 606 includes step 608, in which the integrated communications device is operated to configure its single cellular module as a femtocell. Operation proceeds from step 604 to step 610.

In step 610 the integrated communications device is operated in the normal mode (no outage mode). Step 610 includes step 612, 614 and 616. In step 614 the integrated communications device operates its femtocell to provide service to UEs. In step 614, the integrated communications device operates its WiFi AP to provide service to WiFi stations. In step 616 the integrated communications device is operated to use a cable/optical interface included in the integrated communications device for backhaul communications.

Step 612 includes steps 618, 620 and 622. In step 618 the integrated communications device operates its femtocell to broadcast base station (BS) identifier (ID) and configuration information corresponding to the femtocell. In step 620 the integrated communications device operates its femtocell to establish wireless connections with UEs. In step 622 the integrated communications device operates its femtocell to communicate downlink and uplink control and traffic data signals to UEs being serviced by the femtocell.

Step 614 includes steps 624, 626 and 628. In step 624 the integrated communications device operates its WiFi AP to broadcast network ID information. In step 626 the integrated communications device operates its WiFi AP to establish connections with WiFi stations (STAs). In step 628 the integrated communications device operates its WiFi AP to communicate downlink and uplink control and traffic signals to STAs being service by the WiFi AP.

Step 616 includes step 630. In step 630 the integrated communications device is operated to use a cable/optical interface to communicate femtocell data and WiFi data via a cable/optical modem (e.g., cable modem (CM) or optical network unit (ONU)), to the core network, e.g., a 5G mobile network operator (MNO) core network, corresponding to the femtocell.

Operation proceeds from step 610 to step 632. In step 632 the integrated communications device is operated to monitor to detect an ISP network outage. The ISP network outage is, e.g., a complete loss of the communications over the cable/optical interface or a degradation in performance over the cable/optical interface to below an acceptable threshold, e.g., an unacceptable low bandwidth, an unacceptably low data rate, an unacceptable low throughput, or unacceptable high latency, or unacceptable high bit error rate. Step 632 may, and sometimes does include step 634, in which the integrated communications device detects an ISP network outage. In some embodiments, the detected ISP network outage is based on a lack of received communications signals over the cable/optical interface and, in some embodiments, a watchdog timer timing out. In some embodiments, the detected ISP network outage is based on measurements performed and evaluated by the integrated communications device. In some embodiments, the detected ISP network outage is based on information, e.g., measurements performed and evaluated, by a device, e.g., a network monitoring device, external to the integrated communications device, and a received message from the external device indicating a detected outage or an anticipated outage. In some embodiments, an anticipated outage is due to planned maintenance, a repair, a component replacement, or a hardware/software upgrade.

Operation proceeds from step 634 to step 636. In step 636 the integrated communications device is operated to re-configured in response to the detected ISP network outage. Step 636 includes step 638, in which the integrated communications device is operated to rec-configured to outage mode. Step 638 includes step 640 in which the integrated communications device reconfigured its single cellular module to operate as a cellular modem, providing wide area network (WAN) connectivity. Step 640 includes step 642 in which the integrated communications device ceases broadcasting the base station ID and configuration information corresponding to the femetocell. Operation proceeds from step 636 via connecting node A 644 to step 646.

In step 646 the integrated communications device is operated in outage mode. Step 646 includes steps 648 and 650. In step 648 the integrated communications device operates its WiFi AP to continue to provide service to WiFi stations. In step 650, the integrated communications device operates its single cellular module to operate as a cellular modem, providing cellular WAN connectivity. Step 650 includes step 652, in which the integrated communications device operates its single cellular module to communicate cellular signals to a base station, e.g., a MNO macro cell base station, said cellular signals conveying user data corresponding to WiFi stations.

Operation proceeds from step 646 to step 654. In step 654 the integrated communications device is operated to monitor to detect that the ISP network outage has been resolved. Step 654 may, and sometimes does, include step 656, in which the integrated communications device detects that the ISP network outage has been resolved, e.g., service has been restored. Operation proceeds from step 656 to step 658.

In step 658 the integrated communications device is operated to reconfigure in response to the detected ISP outage resolution. Step 658 includes step 660, in which the integrated communications device reconfigured to normal mode (no outage mode). Step 660 includes step 662, in which the integrated communications device reconfigures its single cellular module to operate as a femtocell. Step 662 includes step 664, in which the integrated communications device controls its single cellular module, functioning as a femtocell, to start broadcasting a base station ID and configuration information corresponding to the femtocell. Operation proceeds from step 658 to step 666.

In step 666 the integrated communications device is operated in the normal mode (no outage mode.) Step 666 includes step 668, 670 and 672. In step 668 the integrated communications device operates its femtocell to provide service to UEs. In step 670, the integrated communications device continues to operate its WiFi AP to provide service to WiFi stations. In step 672 the integrated communications device is operated to use a cable/optical interface included in the integrated communications device for backhaul communications.

Step 668 includes steps 674, 676 and 678. In step 674 the integrated communications device operates its femtocell to broadcast base station (BS) ID and configuration information corresponding to the femtocell. In step 676 the integrated communications device operates its femtocell to establish wireless connections with UEs. In step 678 the integrated communications device operates its femtocell to communicate downlink and uplink control and traffic data signals to UEs being serviced by the femtocell.

Step 672 includes step 680. In step 680 the integrated communications device is operated to use a cable/optical interface to communicate femtocell data and WiFi data via a cable/optical modem (e.g., cable modem (CM) or optical network unit (ONU)), to the core network, e.g., a 5G mobile network operator (MNO) core network, corresponding to the femtocell.

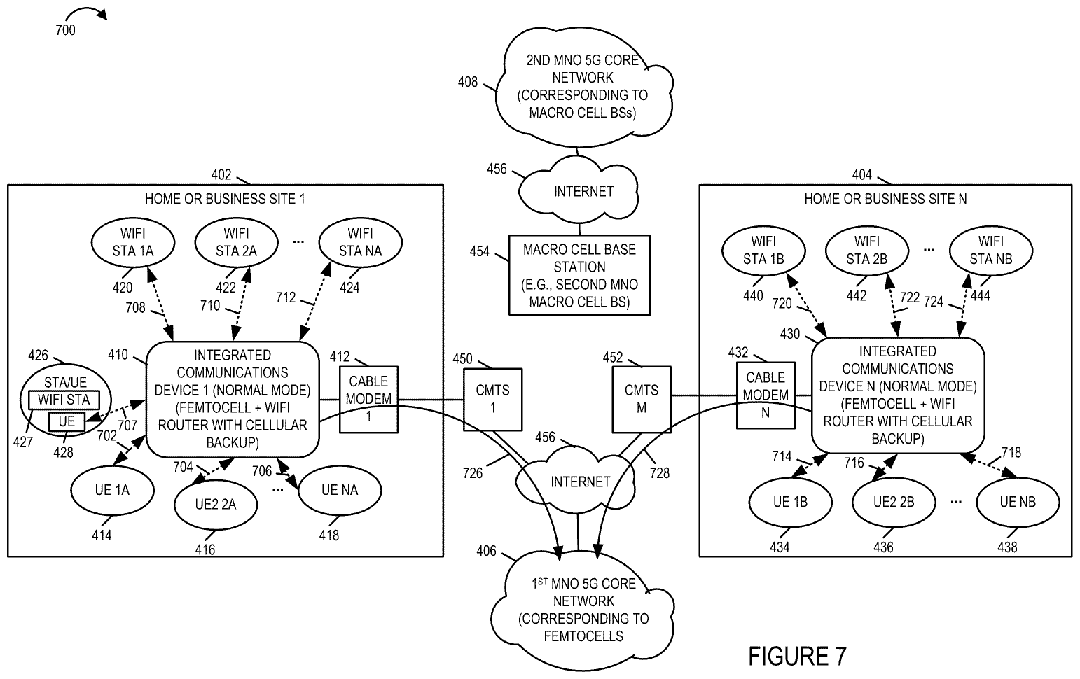

FIG. 7 is a drawing 700 illustrating the system 400 of FIG. 4 for a scenario in which both first and second integrated communications devices (integrated communications device 1 410, integrated communications device N 430) are operating in a normal mode of operation.

The single cellular module of integrated communications device 1 410 is configured to function as a femtocell and is broadcasting base station ID information and configuration information corresponding to the femtocell. UEs (UE 1A 414, UE 2A 416, UE NA 418) have established cellular wireless connections (702, 704, 706) with the femtocell of integrated communications device 1 410 and are communicating cellular signals, e.g. 5G cellular signals including control data and traffic data over those cellular wireless connection (702, 704, 706). UE module 428 of device 426 has also established a cellular wireless connection 707 with the femtocell of integrated communications device 1 410 and is communicating control data and traffic data over cellular wireless connection 707. The WiFi access point of integrated communications device 1 410 is broadcasting its network ID, and has established wireless WiFi connections (708, 710, 712) with WiFi STAs (WiFi STA 1A 420, WiFi STA 2A 422, WiFi STA NA 424), respectively, over which WiFi signals including control data and traffic data are communicated. Integrated communications device 1 410 is using a backhaul communications path 726 to 1st MNO core network 406, which travers cable modem 1 412, CMTS 1 450, and Internet 456.

The single cellular module of integrated communications device N 430 is configured to function as a femtocell and is broadcasting base station ID information and configuration information corresponding to the femtocell. UEs (UE 1B 434, UE 2B 436, UE NB 438) have established cellular wireless connections (714, 716, 718) with the femtocell of integrated communications device N 430 and are communicating cellular signals, e.g. 5G cellular signals including control data and traffic data over those cellular wireless connection (714, 716, 718). The WiFi access point of integrated communications device N 430 is broadcasting its network ID, and has established wireless WiFi connections (720, 722, 724) with WiFi STAs (WiFi STA 1B 440, WiFi STA 2B 442, WiFi STA NA 444), respectively, over which WiFi signals including control data and traffic data are communicated. Integrated communications device N 430 is using a backhaul communications path 728 to 1st MNO core network 406, which traverses cable modem N 432, CMTS M 452, and Internet 456.

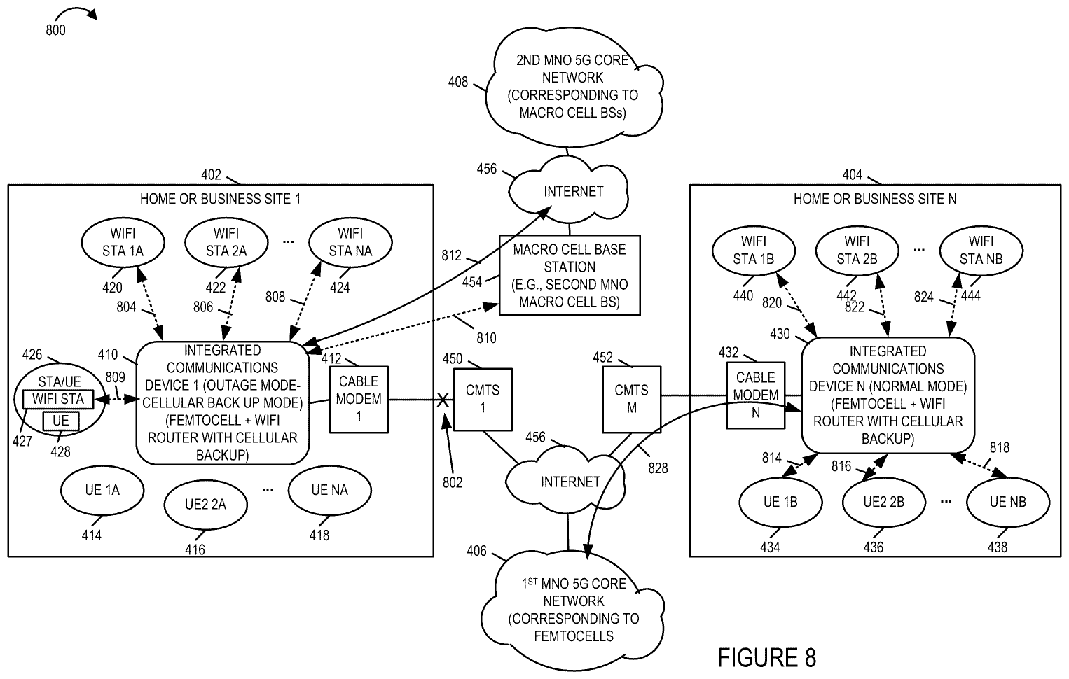

FIG. 8 is a drawing 800 illustrating the system 400 of FIG. 4 for a scenario in which a first integrated communications device, integrated communications device 1 410, is operating in an outage mode of operation (sometimes referred to as cellular back up mode of operation or a cellular backhaul mode of operation) and a second integrated communications device, integrated communications device N 430, is operating in a normal mode of operation.

Integrated communications device 1 410 is operating in an outage mode of operation due to a detected ISP outage as indicated by X 802 between cable modem 1 412 and CMTS 1 450. The single cellular module of integrated communications device 1 410 is configured to function as a cellular modem and provide cellular WAN connectivity. Integrated communications device 1 410 establishes and uses wireless cellular connection 810 between its cellular module, configured as a cellular modem, and macro base station 812. Thus, the single cellular module is being used as a cellular back up for the WiFi router, due to the outage along the cable modem path, and the femtocell is off and does not provide service to UEs during the outage mode of operation. The WiFi access point of integrated communications device 1 410 is broadcasting its network ID, and has established wireless WiFi connections (804, 806, 808) with WiFi STAs (WiFi STA 1A 420, WiFi STA 2A 422, WiFi STA NA 424), respectively, over which WiFi signals including control data and traffic data are communicated. The WiFi access point of integrated communications device 1 410 has also established a wireless WiFi connection (809) with WiFi STA module 427 of device 426 over which WiFi signals including control data and traffic data are communicated. Integrated communications device 1 410 is using a backhaul communications path 812 to Internet 456, which traverses macro cell base station 454.

The single cellular module of integrated communications device N 430 is configured to function as a femtocell and is broadcasting base station ID information and configuration information corresponding to the femtocell. UEs (UE 1B 434, UE 2B 436, UE NB 438) have established cellular wireless connections (814, 816, 818) with the femtocell of integrated communications device N 430 and are communicating cellular signals, e.g. 5G cellular signals including control data and traffic data over those cellular wireless connection (814, 816, 818). The WiFi access point of integrated communications device N 430 is broadcasting its network ID, and has established wireless WiFi connections (820, 822, 824) with WiFi STAs (WiFi STA 1B 440, WiFi STA 2B 442, WiFi STA NA 444), respectively, over which WiFi signals including control data and traffic data are communicated. Integrated communications device N 430 is using a backhaul communications path 828 to 1st MNO core network 406, which traverses cable modem N 432, CMTS M 452, and Internet 456.

FIG. 9 is a flowchart 900 of an exemplary method of operating a communications device, e.g., integrated communications device 410 of FIGS. 4, 7 and 8 or integrated communications device 500 of FIG. 5, including a WiFi access point (AP) and a cellular communications module, in accordance with an exemplary embodiment. Operation of the exemplary method starts in step 902, in which the communications device is powered on and initialized. Operation proceeds from start step 902 to steps 904 and 906.

In step 904, the communications device is operated in a normal mode of operation. Step 904 includes steps 908, 910 and 912. In step 908 the communications device operates the cellular communications module as a femtocell at the customer premises where the communications device is located, e.g., the cellular communications module is operated to provide cellular service to one or more UEs at the customer premises where the communications device is located. In some embodiments step 908 includes the some or all of the steps included in previously discussed step 610 which was discussed with regard to FIG. 6A. In the FIG. 9 example step 908 explicitly includes steps 914 and 916. In step 914 a cellular transmitter in the cellular communications module of the communications device is operated to transmit a base station identifier (BS ID), e.g., where the BSID is an identifier corresponding to the femtocell and which can be detected and used by cellular UEs to obtain cellular communications service from the communications device while the cellular communications module operates as a femtocell. In step 916 the cellular communications module is operated to provide cellular service to one or more user equipments (UEs). In step 910, the WiFi AP is operated to provide WiFi service, e.g., to one or more WiFi stations (STAs) at the customer premises where the communications device is located. Step 910 includes step 918, in which the WiFi AP is operated to provide WiFi service to one or more stations (STAs). In step 912 the communications device is operated to communicate data over a first backhaul communications connection (e.g., a non-wireless backhaul connection to a first communications network, e.g., to a 1st MNO 5G core network 406 which corresponds to the femtocell), said first backhaul communications connection being a cable or optical backhaul connection. Step 912 includes steps 920 and 922. In step 920 the communications device is operated to communicate data to and/or from the femtocell over the first backhaul communications connection. In step 922 the communications device is operated to communicate data to and/or from the WiFi AP over the first backhaul communication connection. Step 904 is performed, repetitively, on an ongoing basis while the communications device remains in the normal mode of operation.

Returning to step 906, in step 906, the communications device monitors, during the normal mode of operation, the first backhaul communications connection, e.g., to detect a first backhaul communications connection outage which prevents use of the first backhaul communications connection. Step 906 is performed repeatedly on an ongoing basis. Step 906 may, and sometimes does, includes step 906, in which the communications device detects a first backhaul communications connection outage. Operation proceeds from step 924 to step 926.

In step 926 the communications device switches from the normal mode of operation to a cellular backhaul mode of operation in response to detecting a first backhaul communications connection outage. In some embodiments the switching includes performing the re-configuration operations of step 636 shown in FIG. 6A. Operation proceeds from step 926 to step 928.

In step 928 the communications device operated in the cellular backhaul mode of operation during at least a portion of the first backhaul communications connection outage, wherein operating the in the cellular backhaul mode of operation including using the cellular communications module to operate as a cellular modem instead of operating as a femtocell, while continuing to operate the WiFi AP to provide WiFi service. In some embodiments step 928 includes all or some of the steps included in outage mode operation step 646 previously discussed with regard to FIG. 6B. In the FIG. 9 example step 928 explicitly includes step 929, in which the communications device, as part of operating in the cellular backhaul mode of operation, communicates data to and/or from the WiFi AP over a wireless backhaul to cellular network via the cellular communications module. For example, the cellular communications module, operating as a cellular modem, communicates, e.g., relays data to/from macro cell base station 454 of a second MNO cellular network. Operation proceeds from step 928 to step 930.

In step 930 the communications device monitors the first backhaul communications connection, during said cellular backhaul mode of operation, to determine if the first backhaul communications connection is operational. Step 930 is performed on an ongoing basis, e.g., repeatedly, while in the cellular backhaul mode of operation. Step 930 may, and sometimes does include step 932. In step 932 the communications device determines that said first backhaul communications connection is operational. Operation proceeds from step 932 to step 934.

In step 934, the communications device switches from the cellular backhaul mode of operation to the normal mode of operation, in response to determining that the first backhaul communications connection is operational. In some embodiments step 934 includes all or some of the steps included in previously discussed in regard to reconfiguration step 656 of FIG. 6B. Step 934 in the FIG. 9 example explicitly includes steps 936, 938 and 940. In step 936 the communications device ceases cellular modem operation by the cellular communications module, e.g., the communications device stops using the cellular communications module to relay traffic data via a cellular network for devices using the WiFi AP. In step 938 the communications device is operated to transmit said BS ID from the cellular communications module (e.g., the communications device resumes transmission of the BS ID), said cellular communications module operating as a femtocell and the BS ID corresponding the femtocell. In step 940 the communications device is operated to provide cellular service to one or more cellular UEs. Operation proceeds from step 934 to the input of step 904, in which the communications device continues to operate in the normal mode of operation.

In various embodiments, the cellular communications module, including in the communications device (e.g., integrated communications device 410 or 500), implementing the method of flowchart 900 of FIG. 9, is capable of operating as one of a femtocell or cellular modem at any given dime but not both. In various embodiments the cellular communications module (e.g., cellular communications module 504) includes a single cellular transceiver (515) including a cellular transmitter (518) and a cellular receiver (516), said communications device not including any additional cellular transmitters or receivers. For example, the communications device (410 or 500) is capable as operating as a femtocell or a cellular modem but not both due to the presence of a single cellular transmitter (518) and a single cellular receiver (516) without having additional cellular transmitters/receivers that might otherwise allow the communications device (410 or 500) to support femtocell and cellular backup operations at the same time.

In various embodiments, during said normal mode of operation, the communications device provides cellular service to one or more UEs while the WiFi access point provides WiFi service to one or more WiFi capable devices (e.g., WiFi stations (STAs)) with network and/or Internet connectivity being provided to the one or more UEs and WiFi capable devices via the first backhaul communications connection.

In various embodiments, the cellular backhaul mode of operation of operation, the communications device provides network and/or Internet connectivity to WiFi stations via the cellular communications module and does not provide cellular service to UEs.

In some embodiments, said femtocell is a Citizens Broadband Radio Services (CBRS) femtocell.

In some embodiments, the femtocell supports a higher Quality of Service (QoS) level data flow than any data flows supported by the WiFi access point. In some embodiments, said higher QoS level data flow supported by the femtocell has a higher Guaranteed Bit Rate (GBR) than any of the data flows supported by the WiFi access point. In some embodiments, said higher QoS level data flow supported by the femtocell has a lower latency requirement than any of the data flows supported by the WiFi access point. In some embodiments, said femtocell supports Low Latency Low Loss and Scalable Throughput (L4S) data flows and said WiFi access point does not.

In various embodiments, said cellular communications module uses a first set of spectrum, when operating as a femtocell during the normal mode of operation, and uses a second set of spectrum, when operating a cellular modem during the cellular backup mode of operation, said first and second sets of spectrum being different. In some such embodiments, said first spectrum corresponds to a first service provider (e.g., a 1st MNO service provider to which the femtocell belongs) and wherein said second set of spectrum corresponds to a second service provider (e.g., a 2nd MNO service provider to which a macro cell base station belongs), said first and second service providers being different.

Various aspects and/or features of some embodiments of the present invention are described below. A single cellular module included in an integrated communications device is utilized to act as either a femtocell or a cellular modem, with changes occurring dynamically during operation depending upon what is currently required in the ecosystem. An exemplary cellular module, included in an integrated communications device implemented in accordance with the present invention, includes appropriate hardware and software components to be able to operate in both modes. In various embodiments, by default the integrated cellular module will operate as a femtocell, providing cellular connectivity to cellular end user equipment (UE) devices, e.g., 5G cellular smartphones. In the event of an Internet Service Provider (ISP) network outage, the integrated cellular module will reconfigure as a cellular modem, providing cellular wide area network (WAN) connectivity. Once the ISP network outage has been resolved, the integrated cellular module will reconfigure as a femtocell. Since the same cellular module, which is a single cellular module in the integrated communications device, is utilized to perform different functions at different times, the cost and the number of devices needed in one installment site, e.g., a home or small business site, is minimalized.

A single cellular module, included in an integrated communications device, is configured and controlled to function as either: i) a femtocell or ii) cellular modem as part of a router with cellular back up, at different times. This approach of controlling the single cellular module, in the integrated communications device to switch between two different functions can be, and sometimes is, implemented as part of a two-mode approach.

In a first mode, referred to as normal mode or no outage mode, the single cellular module, in the integrated communications device, is controlled to function as a femtocell. In normal or no outage mode the router is not using the single cellular module, but the femtocell is. In the normal or no outage mode, the femtocell provides connectivity for end user cellular devices such as UE cellphones being serviced by the femtocell via the router and a cable modem (CM)/optical network unit (ONU), and the Internet, to a core mobile network, e.g., a 5G core mobile network corresponding to the femtocell. In the normal or no outage mode, a WiFi AP, included as part of the router, provides connectivity for WiFi stations (STAs) being serviced by the WiFi AP via the router and a cable modem (CM)/optical network unit (ONU), to the Internet and/or to a core network, e.g., a 5GC core network corresponding to the femtocell.

In a second mode, referred to as an outage mode, the single cellular module, in the integrated communications device, is controlled to function as a cellular modem, providing an active cellular back up for the router. In the outage mode the femtocell is off. In the outage mode, the router is using the single cellular module; therefore, the femtocell can't use the single cellular module, so the femtocell switches off. In the outage mode, the WiFi AP, included as part of the router, provides connectivity for WiFi stations (STAs) being serviced by the WiFi AP via single cellular module, acting as a cellular modem, and a base station, e.g., a 5G macro cell base station, to the Internet.

Various system benefits of the present invention will now be described. Existing components in WiFi router with an integrated cellular module can be, and sometimes are, utilized, in accordance with the present invention, to operate as a femtocell or a cellular modem at appropriate times. An exemplary system, in accordance with the present invention, provides the benefits of both modes. In the normal (no outage) mode of operation, which is the predominant mode, the single cellular module functions as a femtocell, which supports cellular capable end user devices. The femtocell provides fronthaul connectivity with improved QoS, increased offload capability, and increased technology coverage as compared to what is typically provided by a WiFi AP to WiFi stations. In the outage mode of operation, which is the infrequently used mode, the single cellular module functions as a cellular modem. From the perspective of the WiFi router, the WiFi router has dual WAN connectivity, a primary cable modem (CM)/ optical network unit (ONU) backhaul path, and a secondary cellular modem backhaul path in the event of a failure of the first primary path.

The approach of the present invention, involving using a single cellular module to function as either a femtocell or a cellular modem at different times in response to current system conditions, is a cost effective approach for implementing and/or expanding a Citizens Broadband Radio Services (CBRS)/5G private network for Mobile Virtual Network Operators (MVNOs) and/or Mobile Network Operators (MNOS) through femtocells.

In various exemplary embodiments, switching between the two modes can be, and sometimes are, achieved in either or both of two ways. In a first approach automatic switching is implemented, which requires no interaction from the customer, to provide the best benefits possible given the ecosystem performance. In a second approach, manual switching allows the customer to select which benefits to experience and when to perform switching. For example, if a customer is only using WiFi devices, at a particular time, and does not have any cellular devices to be supported at that time, the customer may select to control the single cellular module to function as a cellular modem and the backhaul may be split between i) the wireline/optical cable modem/ONU path and ii) the cellular modem path. Accordingly, in some embodiments a customer can manually select a Femtocell mode of operation, in which the cellular module operates as a Femtocell, to gain the benefits of a cellular network extended to the home and at another point in time, the customer can select a Dual WAN Connectivity mode of operation. In the Dual WAN connectivity mode of operation, the cellular module operates as a Cellular Modem providing the customer the benefit of two avenues of northbound (e.g., network bound) traffic for reliability or optionality allowing offload of traffic where required or desired.

A novel feature of the present invention is that a single cellular mode is utilized to act as either a femtocell or a cellular modem dynamically depending on what is required in the ecosystem. Various embodiments, in accordance with the present invention, are beneficial for MVNOs/MNOs and ISPs that deploy a WiFi router with an integrated cellular module. By implementing and using methods and apparatus in accordance with the present invention, ISPs can utilize existing components in a WiFi router with an integrated cellular module to operate the cellular module as either: i) a femtocell or ii) a cellular modem at appropriate times, e.g., depending upon current conditions. Methods and apparatus in accordance with the present invention can reduce network operational cost for a network service provider and can provide an improved level of service to customers.

### Numbered List of Exemplary Method Embodiments

### Method Embodiment 1

A method of operating a communications device (410 or 500) including a Wireless Local Area Network (WLAN) access point (e.g., WiFi access point (506)) and cellular communications module (504), the method comprising: operating (904) the communications device in a normal mode of operation, said step of operating (904) the communications device in a normal mode of operation including operating (908) the cellular communications module as a femtocell (e.g., operate the cellular communications module to provide cellular service to one or more UEs) at a customer premises where the communications device (410) is located, operating (910) the WLAN access point to provide WLAN service (e.g., WiFi service) to one or more WLAN stations (e.g., WiFi stations) (STAs) at the customer premises where the communications device is located), and communicating (912) data over a first backhaul communications connection (e.g., a non-wireless backhaul connection to a first communications network), said first backhaul communications connection being a cable or optical backhaul connection; monitoring (906), during the normal mode of operation, the first backhaul communications connection (e.g., to detect a first backhaul communications connection outage which prevents use of the first backhaul communications connection); switching (926) the communications device from the normal mode of operation to a cellular backhaul mode of operation in response to detecting a first backhaul communications connection outage; and operating (928) in the cellular backhaul mode of operation during at least a portion of the first backhaul communications connection outage, wherein operating in the cellular backhaul mode of operation includes using the cellular communications module to operate as a cellular modem instead of as a femtocell while continuing to operate the WLAN access point to provide WLAN service (e.g., WiFi service).

### Method Embodiment 1A

The method of Method Embodiment 1, wherein operating (908) the cellular communications module as a femtocell includes operating (914) a cellular transmitter in the cellular communications module to transmit a base station identifier (BS ID) (e.g., where the BS ID is an identifier corresponding to the femtocell and which can be detected and used by cellular UEs to obtain cellular communications service from the communications device while the cellular communications module operates as a femtocell).

### Method Embodiment 2

The method of Method Embodiment 1, wherein said cellular communications module is capable of operating as one of a femtocell or cellular modem at any given time but not both.

### Method Embodiment 2A

The method of Method Embodiment 2, wherein the WLAN access point is a WiFi access point; and wherein said cellular communications module (504) includes a single cellular transceiver (515) including a cellular transmitter (518) and a cellular receiver (516), said communications device not including any additional cellular transmitters or receivers (e.g., the communications device (410 or 500) is capable of operating as a femtocell or a cellular modem but not both due to the presence of a single cellular transmitter (518) and single cellular receiver (516) without having additional cellular transmitters/receivers that might otherwise allow the communications device (410 or 500) to support femtocell and cellular backhaul operations at the same time).

### Method Embodiment 3

The method of Method Embodiment 1, wherein operating (904) the communications device in the normal mode of operation includes communicating (920) data to or from the WiFi access point over the first backhaul communications connection; and wherein operating (928) in the cellular backhaul mode of operation includes communicating (929) data to or from the WiFi access point over a wireless backhaul connection to a cellular network via the cellular communications module.

### Method Embodiment 4

The method of Method Embodiment 3, further comprising: monitoring (930) said first backhaul communications connection, during said cellular backhaul mode of operation; and in response to said monitoring (930) determining (932) that the first backhaul communications connection is operational, switching (934) from said cellular backhaul mode of operation to said normal mode of operation.

### Method Embodiment 5

The method of Method Embodiment 4, wherein switching (934) from said cellular backhaul mode of operation to said normal mode of operation includes: ceasing (936) cellular modem operation by said cellular communications module (e.g., stop using the cellular communications module to relay data traffic via a cellular network for devices using the WiFi access point); and transmitting (938) (e.g., resuming transmission of the BS ID), from the cellular communications module, a base station (BS) ID.

### Method Embodiment 6

The method of Method Embodiment 5, wherein switching (934) from said cellular backhaul mode of operation to said normal mode of operation includes: providing (940) cellular service to one or more cellular UEs.

### Method Embodiment 7

The method of Method Embodiment 6, wherein during said normal mode of operation, the communications device provides (916) cellular service to one or more UEs while the WiFi access point provides (918) WiFi service to one or more WiFi capable devices (e.g., WiFi stations (STAs)) with network and/or Internet connectivity being provided to the one or more UEs and WiFi capable devices via the first backhaul communications connection (912).

### Method Embodiment 8

The method of Method Embodiment 7, wherein during the cellular backhaul mode of operation of operation, the communications device provides network and/or Internet connectivity to WiFi stations via the cellular communications module and does not provide cellular service to UEs.

### Method Embodiment 9

The method of Method Embodiment 1, wherein said femtocell is a Citizens Broadband Radio Services (CBRS) femtocell.

### Method Embodiment 10

The method of Method Embodiment 1, wherein said femtocell supports a higher Quality of Service (QoS) level data flow than any data flows supported by the WiFi access point.

### Method Embodiment 11

The method of Method Embodiment 10, wherein said higher QoS level data flow supported by the femtocell has a higher Guaranteed Bit Rate (GBR) than any of the data flows supported by the WiFi access point.

### Method Embodiment 12

The method of Method Embodiment 10, wherein said higher QoS level data flow supported by the femtocell has a lower latency requirement than any of the data flows supported by the WiFi access point.

### Method Embodiment 13

The method of Method Embodiment 10, wherein said femtocell supports Low Latency Low Loss and Scalable Throughput (L4S) data flows and said WiFi access point does not.

### Method Embodiment 14

The method of Method Embodiment 1, wherein said cellular communications module uses a first set of spectrum, when operating as a femtocell during the normal mode of operation, and uses a second set of spectrum, when operating a cellular modem during the cellular backup mode of operation, said first and second sets of spectrum being different.

### Method Embodiment 15

The method of Method Embodiment 14, wherein said first spectrum corresponds to a first service provider (e.g., a 1st MNO service provider to which the femtocell belongs) and wherein said second set of spectrum corresponds to a second service provider (e.g., a 2nd MNO service provider to which a macro cell base station belongs), said first and second service providers being different.

### Numbered List of Exemplary Apparatus Embodiments

### Apparatus Embodiment 1

A communications device (410 or 500) comprising: a WiFi access point (506); a cellular communications module (504); and a processor (502) configured to: operate (904) the communications device in a normal mode of operation, said step of operating (904) the communications device in a normal mode of operation including operating (908) the cellular communications module (504) as a femtocell (e.g., operate the cellular communications module (504) to provide cellular service to one or more UEs) at a customer premises where the communications device (410) is located, operating (910) the WiFi access point (506) to provide WiFi service (e.g., to one or more WiFi stations (STAs) at the customer premises where the communications device is located), and communicating (912) data over a first backhaul communications connection (e.g., a non-wireless backhaul connection to a first communications network), said first backhaul communications connection being a cable or optical backhaul connection; operate the communications device to monitor (906), during the normal mode of operation, the first backhaul communications connection (e.g., to detect a first backhaul communications connection outage which prevents use of the first backhaul communications connection); operate the communications device to switch (926) the communications device from the normal mode of operation to a cellular backhaul mode of operation in response to detecting a first backhaul communications connection outage; and operate (928) the communications device in the cellular backhaul mode of operation during at least a portion of the first backhaul communications connection outage, wherein operating the communications device in the cellular backhaul mode of operation includes using the cellular communications module (504) to operate as a cellular modem instead of as a femtocell while continuing to operate the WiFi access point (506) to provide WiFi service.

### Apparatus Embodiment 1A

The communications device of Apparatus Embodiment 1, wherein said processor (502) is configured to: operate (914) a cellular transmitter (518) in the cellular communications module (504) to transmit a base station identifier (BS ID) (e.g., where the BS ID is an identifier corresponding to the femtocell and which can be detected and used by cellular UEs to obtain cellular communications service from the communications device while the cellular communications module (504) operates as a femtocell), as part of being configured to operate (908) the cellular communications module as a femtocell.

### Apparatus Embodiment 2

The communications device of Apparatus Embodiment 1, wherein said cellular communications module (504) is capable of operating as one of a femtocell or cellular modem at any given time but not both.

### Apparatus Embodiment 2A

The communications device of Apparatus Embodiment 2, wherein said cellular communications module (504) includes a single cellular transceiver (515) including a cellular transmitter (518) and a cellular receiver (516), said communications device not including any additional cellular transmitters or receivers (e.g., the communications device (410 or 500) is capable of operating as a femtocell or a cellular modem but not both due to the presence of a single cellular transmitter (518) and single cellular receiver (516) without having additional cellular transmitters/receivers that might otherwise allow the communications device (410 or 500) to support femtocell and cellular backhaul operations at the same time).

### Apparatus Embodiment 3

The communications device of Apparatus Embodiment 1, wherein said processor (502) is configured to: operate the communications device to communicate (920) data to or from the WiFi access point (506) over the first backhaul communications connection, as part of being configured to operate (904) the communications device in the normal mode of operation; and operate the communications device to communicate (929) data to or from the WiFi access point (506) over a wireless backhaul connection to a cellular network via the cellular communications module (504), as part of being configured to operate (928) the communications device in the cellular backhaul mode of operation.

### Apparatus Embodiment 4

The communications device of Apparatus Embodiment 3, wherein said processor (502) is further configured to: operate the communications device to monitor (930) said first backhaul communications connection, during said cellular backhaul mode of operation; and in response to said monitoring (930) determining (932) that the first backhaul communications connection is operational, operate the communications device to switch (934) from said cellular backhaul mode of operation to said normal mode of operation.

### Apparatus Embodiment 5

The communications device of Apparatus Embodiment 4, wherein said processor (502) is configured to: control the communications device to cease (936) cellular modem operation by said cellular communications module (504) (e.g., stop using the cellular communications module to relay data traffic via a cellular network for devices using the WiFi access point); and operate the communications device to transmit (938) (via cellular transmitter 518) (e.g., resuming transmission of the BS ID), from the cellular communications module (504), a base station (BS) ID, as part of being configured to operate the communications device to switch (934) from said cellular backhaul mode of operation to said normal mode of operation.

### Apparatus Embodiment 6

The communications device of Apparatus Embodiment 5, wherein said processor (502) is configured to: operate the communications device to provide (940) cellular service to one or more cellular UEs, as part of being configured to operate the communications device to switch (934) from said cellular backhaul mode of operation to said normal mode of operation.

### Apparatus Embodiment 7

The communications device of Apparatus Embodiment 6, wherein during said normal mode of operation, the communications device provides (916) cellular service to one or more UEs while the WiFi access point provides (918) WiFi service to one or more WiFi capable devices (e.g., WiFi stations (STAs)) with network and/or Internet connectivity being provided to the one or more UEs and WiFi capable devices via the first backhaul communications connection (912).

### Apparatus Embodiment 8

The communications device of Apparatus Embodiment 7, wherein during the cellular backhaul mode of operation of operation, the communications device provides network and/or Internet connectivity to WiFi stations via the cellular communications module and does not provide cellular service to UEs.

### Apparatus Embodiment 9

The communications device of Apparatus Embodiment 1, wherein said femtocell is a Citizens Broadband Radio Services (CBRS) femtocell.

### Apparatus Embodiment 10

The communications device of Apparatus Embodiment 1, wherein said femtocell supports a higher Quality of Service (QoS) level data flow than any data flows supported by the WiFi access point.

### Apparatus Embodiment 11

The communications device of Apparatus Embodiment 10, wherein said higher QoS level data flow supported by the femtocell has a higher Guaranteed Bit Rate (GBR) than any of the data flows supported by the WiFi access point.

### Apparatus Embodiment 12

The communications device of Apparatus Embodiment 10, wherein said higher QoS level data flow supported by the femtocell has a lower latency requirement than any of the data flows supported by the WiFi access point.

### Apparatus Embodiment 13

The communications device of Apparatus Embodiment 10, wherein said femtocell supports Low Latency Low Loss and Scalable Throughput (L4S) data flows and said WiFi access point does not.

### Apparatus Embodiment 14

The communications device of Apparatus Embodiment 1, wherein said cellular communications module uses a first set of spectrum, when operating as a femtocell during the normal mode of operation, and uses a second set of spectrum, when operating a cellular modem during the cellular backup mode of operation, said first and second sets of spectrum being different.

### Apparatus Embodiment 15

The communications device of Apparatus Embodiment 14, wherein said first spectrum corresponds to a first service provider (e.g., a 1st MNO service provider to which the femtocell belongs) and wherein said second set of spectrum corresponds to a second service provider (e.g., a 2nd MNO service provider to which a macro cell base station belongs), said first and second service providers being different.

### Numbered List of Exemplary Non-Transitory

### Computer Readable Medium Embodiments

### Non-Transitory Computer Readable Medium Embodiment 1

A non-transitory computer readable medium (512) including machine readable instructions, which when executed by a processor (502) of a communications device (410 or 500) including a WiFi access point (506) and cellular communications module (504), control the communications (410 or 500) to perform the steps of: operating (904) the communications device in a normal mode of operation, said step of operating (904) the communications device in a normal mode of operation including operating (908) the cellular communications module as a femtocell (e.g., operate the cellular communications module to provide cellular service to one or more UEs) at a customer premises where the communications device (410) is located, operating (910) the WiFi access point to provide WiFi service (e.g., to one or more WiFi stations (STAs) at the customer premises where the communications device is located), and communicating (912) data over a first backhaul communications connection (e.g., a non-wireless backhaul connection to a first communications network), said first backhaul communications connection being a cable or optical backhaul connection; monitoring (906), during the normal mode of operation, the first backhaul communications connection (e.g., to detect a first backhaul communications connection outage which prevents use of the first backhaul communications connection); switching (926) the communications device from the normal mode of operation to a cellular backhaul mode of operation in response to detecting a first backhaul communications connection outage; and operating (928) in the cellular backhaul mode of operation during at least a portion of the first backhaul communications connection outage, operating in the cellular backhaul mode of operation including using the cellular communications module to operate as a cellular modem instead of as a femtocell while continuing to operate the WiFi access point to provide WiFi service.

The techniques of various embodiments may be implemented using software, hardware and/or a combination of software and hardware. Various embodiments are directed to apparatus, e.g., integrated communications devices including a WiFi access point and a cellular communications module, user equipment (UE) devices, core network devices (e.g., PCF devices, AMF devices, SMF devices, UPF devices, UDM devices, UDR devices, AUSF devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating integrated communications devices including a WiFi access point and a cellular communications module, user equipment (UE) devices, core network devices (e.g., PCF devices, AMF devices, SMF devices, UPF devices, AUSF devices, UDM devices, UDR devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., integrated communications devices including a WiFi access point and a cellular communications module, user equipment (UE) devices, core network devices (e.g., PCF devices, AMF devices, SMF devices, UPF devices, UDM devices, UDR devices, AUSF devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components, or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., an integrated communications device including a WiFi access point and a cellular communications module, user (UE) devices, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., an integrated communications device including a WiFi access point and a cellular communications module, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, node and/or element, with a processor which includes a component corresponding to each of the steps of the various described methods performed by the device in which the processor is included. In some but not all embodiments a device, e.g., an integrated communications device including a WiFi access point and a cellular communications module, user equipment (UE) devices, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., an integrated communications device including a WiFi access point and a cellular communications module, user (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, nodes and/or element. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as an integrated communications device including a WiFi access point and a cellular communications module, a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a communications device including a wireless local area network (WLAN) access point and cellular communications module, the method comprising:
operating the communications device in a normal mode of operation, said step of operating the communications device in a normal mode of operation including operating the cellular communications module as a femtocell at a customer premises where the communications device is located, operating the WLAN access point to provide WLAN service, and communicating data over a first backhaul communications connection, said first backhaul communications connection being a cable or optical backhaul connection;
monitoring, during the normal mode of operation, the first backhaul communications connection;
switching the communications device from the normal mode of operation to a cellular backhaul mode of operation in response to detecting a first backhaul communications connection outage; and
operating in the cellular backhaul mode of operation during at least a portion of the first backhaul communications connection outage, wherein operating in the cellular backhaul mode of operation includes using the cellular communications module to operate as a cellular modem instead of as a femtocell while continuing to operate the WLAN access point to provide WLAN service.

2. The method of claim 1, wherein said cellular communications module is capable of operating as one of a femtocell or cellular modem at any given time but not both.

3. The method of claim 1,
wherein the WLAN access point is a WiFi access point;
wherein operating the communications device in the normal mode of operation includes communicating data to or from the WiFi access point over the first backhaul communications connection; and
wherein operating in the cellular backhaul mode of operation includes communicating data to or from the WiFi access point over a wireless backhaul connection to a cellular network via the cellular communications module.

4. The method of claim 3, further comprising:
monitoring said first backhaul communications connection, during said cellular backhaul mode of operation; and
in response to said monitoring determining that the first backhaul communications connection is operational, switching from said cellular backhaul mode of operation to said normal mode of operation.

5. The method of claim 4, wherein switching from said cellular backhaul mode of operation to said normal mode of operation includes:
ceasing cellular modem operation by said cellular communications module; and
transmitting, from the cellular communications module, a base station (BS) ID.

6. The method of claim 5, wherein switching from said cellular backhaul mode of operation to said normal mode of operation includes:
providing cellular service to one or more cellular UEs.

7. The method of claim 6, wherein during said normal mode of operation, the communications device provides cellular service to one or more UEs while the WiFi access point provides WiFi service to one or more WiFi capable devices with network and/or Internet connectivity being provided to the one or more UEs and WiFi capable devices via the first backhaul communications connection.

8. The method of claim 7, wherein during the cellular backhaul mode of operation of operation, the communications device provides network and/or Internet connectivity to WiFi stations via the cellular communications module and does not provide cellular service to UEs.

9. The method of claim 1, wherein said femtocell is a Citizens Broadband Radio Services (CBRS) femtocell.

10. The method of claim 1, wherein said femtocell supports a higher Quality of Service (QoS) level data flow than any data flows supported by the WiFi access point; and
wherein said higher QoS level data flow supported by the femtocell has a higher Guaranteed Bit Rate (GBR) than any of the data flows supported by the WiFi access point.

11. A communications device comprising:
a wireless local area network (WLAN) access point;
a cellular communications module; and
a processor configured to:
operate the communications device in a normal mode of operation, said step of operating the communications device in a normal mode of operation including operating the cellular communications module as a femtocell at a customer premises where the communications device is located, operating the WLAN access point to provide WLAN service, and communicating data over a first backhaul communications connection, said first backhaul communications connection being a cable or optical backhaul connection;
operate the communications device to monitor, during the normal mode of operation, the first backhaul communications connection;
operate the communications device to switch the communications device from the normal mode of operation to a cellular backhaul mode of operation in response to detecting a first backhaul communications connection outage; and
operate the communications device in the cellular backhaul mode of operation during at least a portion of the first backhaul communications connection outage, wherein operating the communications device in the cellular backhaul mode of operation includes using the cellular communications module to operate as a cellular modem instead of as a femtocell while continuing to operate the WLAN access point to provide WLAN service.

12. The communications device of claim 11, wherein said cellular communications module is capable of operating as one of a femtocell or cellular modem at any given time but not both.

13. The communications device of claim 11, wherein said processor is configured to: operate the communications device to communicate data to or from the WLAN access point over the first backhaul communications connection, as part of being configured to operate the communications device in the normal mode of operation; and
operate the communications device to communicate data to or from the WLAN access point over a wireless backhaul connection to a cellular network via the cellular communications module, as part of being configured to operate the communications device in the cellular backhaul mode of operation.

14. The communications device of claim 13, wherein said processor is further configured to:
operate the communications device to monitor said first backhaul communications connection, during said cellular backhaul mode of operation; and
in response to said monitoring determining that the first backhaul communications connection is operational, operate the communications device to switch from said cellular backhaul mode of operation to said normal mode of operation.

15. The communications device of claim 14, wherein said processor is configured to:
control the communications device to cease cellular modem operation by said cellular communications module; and
operate the communications device to transmit, from the cellular communications module, a base station (BS) ID,
as part of being configured to operate the communications device to switch from said cellular backhaul mode of operation to said normal mode of operation.

16. The communications device of claim 15, wherein said processor is configured to:
operate the communications device to provide cellular service to one or more cellular UEs, as part of being configured to operate the communications device to switch from said cellular backhaul mode of operation to said normal mode of operation.

17. The communications device of claim 16,
wherein the WLAN access point is a WiFi access point; and
wherein during said normal mode of operation, the communications device provides cellular service to one or more UEs while the WiFi access point provides WiFi service to one or more WiFi capable devices with network and/or Internet connectivity being provided to the one or more UEs and WiFi capable devices via the first backhaul communications connection.

18. The communications device of claim 17, wherein during the cellular backhaul mode of operation of operation, the communications device provides network and/or Internet connectivity to WLAN stations via the cellular communications module and does not provide cellular service to UEs, said WLAN stations being WiFi stations.

19. The communications device of claim 11, wherein said femtocell is a Citizens Broadband Radio Services (CBRS) femtocell.

20. A non-transitory computer readable medium including machine readable instructions, which when executed by a processor of a communications device including a WLAN access point and cellular communications module, control the communications to perform the steps of:
operating the communications device in a normal mode of operation, said step of operating the communications device in a normal mode of operation including operating the cellular communications module as a femtocell at a customer premises where the communications device is located, operating the WLAN access point to provide WLAN service, and communicating data over a first backhaul communications connection, said first backhaul communications connection being a cable or optical backhaul connection;
monitoring, during the normal mode of operation, the first backhaul communications connection;
switching the communications device from the normal mode of operation to a cellular backhaul mode of operation in response to detecting a first backhaul communications connection outage; and
operating in the cellular backhaul mode of operation during at least a portion of the first backhaul communications connection outage, operating in the cellular backhaul mode of operation including using the cellular communications module to operate as a cellular modem instead of as a femtocell while continuing to operate the WLAN access point to provide WLAN service.
